(19) United States
(12) Patent Application Publication
(10) Pub. No.: US 2016/0297307 A1
(43) Pub. Date: Oct. 13, 2016

(54) ELECTRIC VEHICLE WITH FAST-CHARGE FUNCTION

(71) Applicant: AUDI AG, lngolstadt (DE)

(72) Inventors: Michael Hinterberger, lngolstadt (DE); BERTHOLD HELLENTHAL, Schwanstetten (DE)

(73) Assignee: AUDI AG, lngolstadt (DE)

(21) Appl. No.: 15/094,018

(22) Filed: Apr. 8, 2016

(30) Foreign Application Priority Data
Apr. 9, 2015 (DE) 10 2015 004 701.9

(51) Int. Cl. B60L 11/18; B60L 11/16; B60L 5/00; B60L 11/00

(52) U.S. Cl. CPC B60L 11/185; B60L 11/1803; B60L 11/1837; B60L 11/005; B60L 11/16; B60L 11/182; B60L 5/005; B60L 2240/62; B60L 2200/42

(57) ABSTRACT

A vehicle includes an electric drive motor for driving the vehicle, an electrochemical accumulator for storing and providing electric energy for the drive motor, the accumulator being configured to only take up a charging power which is smaller than a predetermined maximal power value, an electric auxiliary storage for storing and providing electric energy for the drive motor, the auxiliary storage being configured to take up a charging power during charging which is greater than the maximal power value; a charging device for receiving energy from a vehicle-external charging station as a power pulse which has an amplitude greater that the maximal power value and to store the received energy in the auxiliary storage; and a coupling circuit coupling the auxiliary storage with the accumulator and configured to transmit the energy from the auxiliary storage into the accumulator with a charging power which is smaller than the maximal power value.

### CROSS-REFERENCES TO RELATED APPLICATIONS

This application claims the priority of German Patent Application, Serial No. 10 2015 004 701.9, filed Apr. 9, 2015, pursuant to 35 U.S.C. 119(a)-(d), the content of which is incorporated herein by reference in its entirety as if fully set forth herein.

### BACKGROUND OF THE INVENTION

The present invention relates to a vehicle with an electric drive motor and an electrochemical accumulator for storing and providing electric energy for the drive motor.

The following discussion of related art is provided to assist the reader in understanding the advantages of the invention, and is not to be construed as an admission that this related art is prior art to this invention.

A vehicle of this type is known from DE 10 2011 014 924 A1. This vehicle is configured as an industrial truck and has an electric drive and electric voltage sources. A voltage source is formed by multiple serially connected batteries and the other voltage source is formed by multiple serially connected capacitors. For charging the two voltage sources the industrial truck can be connected with a mains voltage via electric lines.

A disadvantage of such industrial trucks is that in particular for charging the batteries it has to be connected with the mains voltage for a relatively long period of time for example over night. Depending on the circumstances the battery bank may even have to be removed and replaced for a charged battery bank in order to ensure a gentle charging process of the battery bank without leaving the industrial truck non-operational for an excessive amount of time.

A correspondingly connectable and exchangeable battery is known from WO 2010/039795 A2. This reference describes a vehicle which has a battery and a capacitor bank. The battery can be coupled to the capacitor bank via a connection device. By means of the capacitor bank the battery can be supported to operate an electric motor in case of a sudden power increase.

From DE 20 2008 015 230 U1 a charging system for vehicles is known in which wheels of the vehicles roll over induction elements in the ground whereby an electric current is induced in electric conducting elements in the wheels. A disadvantage of this mobile charging system is that the induction increases the rolling resistance of the wheels because according to the principle of the induction always a force is generated which acts against the cause of the induced current.

It would therefore be desirable and advantageous to provide an improved charging system to obviate prior art shortcomings.

### SUMMARY OF THE INVENTION

According to one aspect of the present invention, a vehicle includes an electric drive motor for driving the vehicle, an electrochemical accumulator for storing and providing electric energy for the drive motor, the accumulator being configured to only take up a charging power which is smaller than a predetermined maximal power value, an electric auxiliary storage for storing and providing electric energy for the drive motor, the auxiliary storage being configured to take up a charging power during charging which is greater than the maximal power value; a charging device for receiving energy from a vehicle-external charging station as a power pulse which has an amplitude greater that the maximal power value and to store the received energy in the auxiliary storage; and a coupling circuit coupling the auxiliary storage with the accumulator and configured to transmit the energy from the auxiliary storage into the accumulator with a charging power which is smaller than the maximal power value.

The vehicle has an electric drive motor for driving the vehicle, i.e., an electric machine and an electrochemical accumulator for storing and providing electric energy for the drive motor. The electrochemical accumulator can also be referred to as battery. The accumulator is configured to only take up a charging power smaller than a predetermined maximal power value. In other words at a given operating voltage a charge current of the accumulator has to be limited. This renders the charging of the accumulator time consuming. The vehicle further has an electric auxiliary accumulator for charging and providing energy for the drive motor. The auxiliary storage is configured to take up a charging power greater than the maximal power value during charging. In other words the auxiliary storage can be charged by means of a greater charging power than the accumulator. Further a charging device for receiving energy from the vehicle external charging device is provided.

In order to charge the vehicle with energy from the vehicle external charging station the charging device is configured to receive the energy as a power impulse. The term power impulse means a power flux from the charging station to the charging device, which has an amplitude greater that the maximal power value. In other words the accumulator is not capable to take up the power impulse. A power pulse in particular has a duration, which may be in the range from 1 second to 10 minutes.

Via the power pulse a charging energy is transmitted which results from the amplitude of the power pulse integrated over the time. The charging device is configured to store the received energy in the auxiliary storage. A coupling circuit, which couples the auxiliary storage with the accumulator, is configured to transmit the energy from the auxiliary storage into the accumulator with a charging power smaller than the maximal power value.

The invention has the advantage that the vehicle can repeatedly receive a power pulse during operation, which transmits charging energy form the charging station to the vehicle independent of the maximal power value of the accumulator. Subsequently a gentle charging process of the accumulator is possible in which the coupling switch transmits the received energy form the auxiliary storage into the accumulator. As accumulator for example a lithium Ion accumulator can be provided.

In order to be able to store energy from the power pulse with a charging power greater than the maximal power value the auxiliary storage, according to a refinement, has for the storing the energy received via the charging device, at least one capacitor in particular a dual layer capacitor, and/or a flywheel energy storage and/or a magnetic storage. The storing of the energy as electric field in a capacitor, as rotational energy in a flywheel and/or as magnetic field has the advantage that the received energy can be received with a high charging power from the auxiliary storage. This advantageously shortens the charging process.

According to another advantageous feature of the invention, the charging device can have an electric capacitor element, which is configured to receive the power pulse as electric alternating field. In other words the power is transmitted form the charging station to the charging device by means of an electric alternating field. In contrast to a magnetic alternating field an electric alternating field has the advantage that it does not induce induction currents or eddy currents in magnetically conductive components of the vehicle, for example an outer panel. A transmission of energy by means of an electric alternating field can for example be realized on the basis of the charging system according to WO 2007/107642 A.

According to an embodiment of the invention, it possible to receive the power pulse during a drive of the vehicle, i.e., to recharge the vehicle with energy. In this embodiment an inverter control for controlling an inverter of the drive motor is configured to operate the drive motor during reception of the power pulse. As a result the vehicle can repeatedly receive a power pulse during the drive and thus recharge the accumulator in stages or stepwise.

According to another embodiment of the invention the vehicle is prevented from running empty, i.e., that the accumulator and the auxiliary storage are completely discharged. In this embodiment a processing unit of the vehicle is configured to adjust a route plan to a destination so that the vehicle successively passes or docks at multiple charging stations on the way to the destination. In particular this embodiment is advantageous in the case of pilotless vehicles in which the destination and/or the route plan are predetermined by a central control. The central control can for example be a warehouse management computer. The pilotless vehicle can then adjust the received route plan and/or the route plan to the received destination is that always a sufficient amount of energy is available in the vehicle for operation.

Another embodiment of the present invention enables a particularly efficient operation of the vehicle. In this embodiment the charging device and the auxiliary storage are configured to receive more than 8 kilowatts as power pulse. This renders the charging time at the charging station particularly short.

Another embodiment of the invention utilizes a further energy source in order to charge the accumulator. In this embodiment the auxiliary storage is configured to receive and store electric recuperation power from the drive motor and/or from a converter, which is different from the drive motor. For example in a vehicle which is configured as forklift, the potential energy released during lowering of the load can be converted into electrical recuperation energy by means of a dynamo-electrical converter.

According to another advantageous feature of the invention, the vehicle is configured as industrial truck. The term industrial truck includes for example a forklift or a lift truck. As industrial truck the vehicle most likely repeatedly moves on very similar driving routes so that charging stations can be arranged particularly efficiently.

According to another advantageous feature of the invention the vehicle can be configured as pilotless vehicle. For example the vehicle can be configured as pilotless industrial truck or as a robot. The charging system according to the invention makes it possible that the vehicle is operated in constant operation.

According to another aspect of the present invention, a transport system for transporting items, for example goods in a storehouse, includes at least one vehicle, which represents an embodiment of the vehicle according to the invention. The transport system further includes at least one track for the at least one vehicle and charging stations integrated in the track and/or at the border of the track, wherein each of the charging station is configured to generate a power pulse for the charging device of the at least one vehicle.

For example the charging station can be configured to generate an electric alternating field when the charging device of the vehicle is located within a predetermined charging range of the charging station. The power pulse can also be transmitted wire-based, for example by providing sliding contacts, along which the charging device of the vehicle can slide during driving. Each charging station can be coupled with an electric mains network and can for example each have a capacitor bank for storing the energy for generating the power pulse.

According to a further aspect of the present invention includes operating the vehicle according to the invention so that the vehicle successively drives to a respective charging station and receives a power pulse from the respective charging station. The vehicle temporarily stores energy from the power pulse in its electric auxiliary storage. After leaving the respective charging station the vehicle charges its accumulator with the energy of the power pulse.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of an embodiment of the transport system according tot the invention;

FIG. 2 is a schematic illustration of an embodiment of the vehicle according to the invention;

FIG. 3 is a schematic illustration of electric components of the vehicle of FIG. 2;

FIG. 4 is a schematic representation of a charging station and a charging device, which may for example be provided in the transport system of FIG. 1 and the vehicle of FIG. 2.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

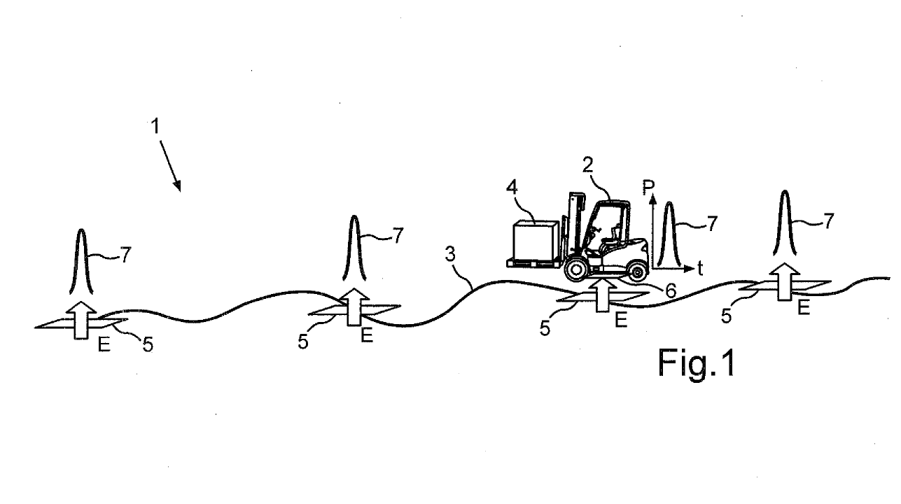

Turning now to the drawing, and in particular to FIG. 1, there is shown a transport system 1, which may for example provided in a warehouse or in a plant for producing a product. The transport system 1 has a vehicle 2 and a track 3 for the vehicle 2. The vehicle 2 can be an industrial truck, for example a forklift. The track 3 can be a driveway or a road for the vehicle 2. The track 3 can for example extend between (not shown) shelves.

The vehicle 2 is shown in FIG.,1 on a drive along track 3. The vehicle 2 can for example transport a transport part 4, for example a box. Along the extent of the track 3 multiple charging stations 5 are arranged or example in a bottom of the track 3 or at a border of the track 3.

The motor vehicle 2 drives using electric energy. The vehicle 2 receives the electric energy by means of a charging device 6, which can be arranged for example on a bottom of a chassis of the motor vehicle 2. When the motor vehicle 2 drives over a charging station 5 or drives past a charging station 5 or stops at a charging station energy E is transmitted from the charging station 5 to the charging device 6 of the vehicle 2. The energy E is transmitted as power pulse 7, i.e., over the time t power is transmitted with an amplitude P, wherein the amplitude P can be in a range greater than 8 kilowatts. A duration of the power pulse 7 can be within a range of for example from 1 second to 10 minutes. The duration of the power pulse can be so short that the energy E is transmitted while the vehicle 2 drives along the track 3. The vehicle may automatically reduce its speed at the charging station 5 so that sufficient time remains to transmit a predetermined minimal amount of energy E into the vehicle 2 by means of the power pulse 7.

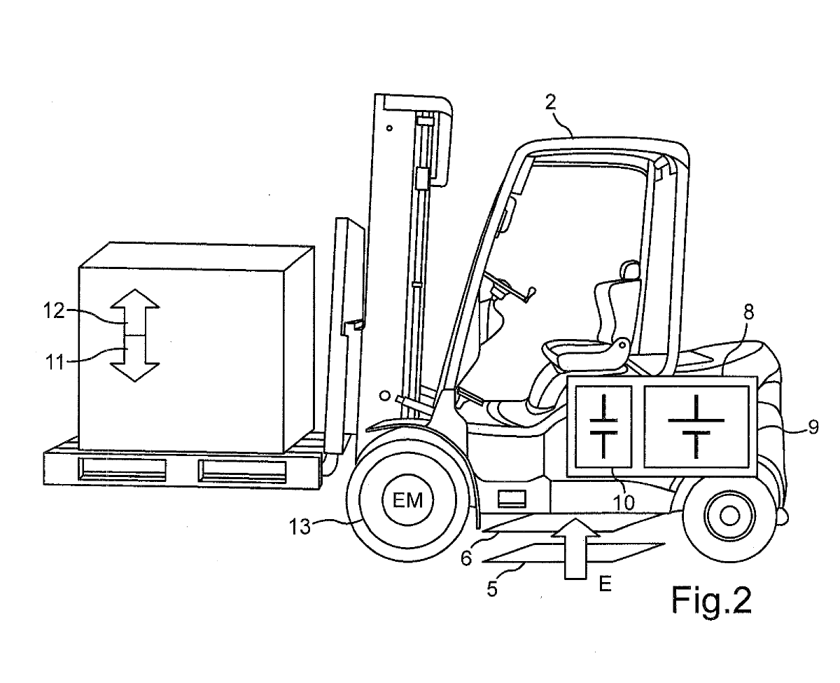

FIG. 2 shows an energy storage device 8 of the vehicle 2 in which the received energy E is stored. The storage device 8 has an electrochemical accumulator 9 which can for example have electrochemical or galvanic cells. The accumulator 9 is preferably configured as lithium-ion-accumulator. A charging power with which the accumulator 9 can be charged, is however smaller than the maximal amplitude P of the power pulse 7.

The storage device 8 further has an auxiliary storage 10, which can for example be constructed on the basis of a dual-layer capacitor or a flywheel energy storage or a magnetic storage. The auxiliary storage 10 is configured to be charged with energy, wherein a maximal charging power of the auxiliary storage 10 is greater than the maximal amplitude P of the power pulse 7.

The received energy E is first stored in the auxiliary storage 10. In the auxiliary storage 10 also recuperation energy can be stored, which is for example obtained during braking of the vehicle 2 or during lowering 11 a load, for example the transport item 4. Energy from the auxiliary storage 10 can also be used to perform a lifting process 12 or an acceleration of the vehicle 2 so that the lifting process 12 and/or the acceleration of the vehicle 2 is not limited by a maximal output power of the accumulator 9.

With the energy of the energy storage 8 also an electric drive motor 13 is operated which, as for example shown in FIG. 2, can be arranged in a wheel of the vehicle 2. The vehicle 2 can have multiple such wheel hub motors. The drive motor 13 is provided by an electric machine EM.

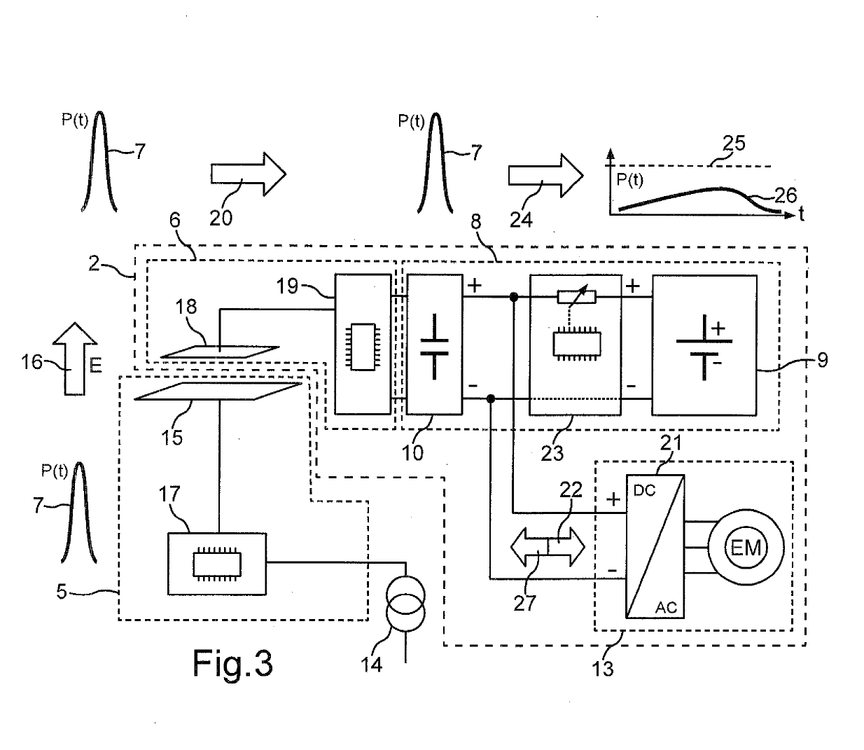

FIG. 3 illustrates how the charging energy is provided by a station 5 and is transmitted into the accumulator 9. FIG. 3 shows a charging station 5 over which the vehicle 2 is located. The charging station 5 can be connected to an electric mains network 14 from which the charging station 5 can for example receive a rotary current, i.e., a multiphase alternating current for example with an effective voltage of 400 volts. For example the charging station 5 can be configured to receive power in the range of 8 kilowatts to 60 kilowatts from the mains supply 14.

For outputting the power pulse 7 the charging station 5 can have a capacitor element 15 by means of which the charging station 5 can generate an electric alternating field 16. A frequency of the alternating field can for example be provided by a control electronics 17. This control electronics can also switch the alternating field 16 on and off. For example the control electronics 17 can receive an identifier and/or a position from the vehicle 2 and can switch on the alternating field 16 in dependence on the identifier and/or position. This ensures that only vehicles are impinged with the alternating field 16 that are configured for receiving the power pulse 7. By analyzing a position it can be ensured that the charging device 6 of the vehicle 2 is located within a predetermined transmission range at the charging station 5. Otherwise the alternating field I 16 is switched off.

The charging device 6 can have a capacitor element 18 via which the charging device 6 receives the alternating field 16. By means of a receiving electronics 19 a DC current can be generated from the AC current generated by the alternating field 16, which DC current can be conducted into the auxiliary storage 10, thereby charging the auxiliary storage 10. For rectifying, the receiving electronics 19 can have a rectifier circuit.

The charging process 20 of the auxiliary storage 10 can be conducted so fast that the auxiliary storage 10 is charged with the power pulse 7, i.e., the charge current at a given DC voltage is of a magnitude, that the energy E can be transmitted from the charging device 6 into the auxiliary storage 10 without any delay. From the auxiliary storage 10 the energy stored therein can if needed be for example directly used for operating the drive motor 13 via an inverter 21. As a result, drive energy 22 flows from the storage device 8 into the drive motor 13. Via the coupling device 23 the energy can be transmitted from the auxiliary storage 10 into the accumulator 9 in a charging process 24. The amplitude P of the thus transmitted power is smaller than a maximal power value 25 which may not be exceeded during charging of the accumulator 9. This results in a power course 26 over time t shown in FIG. 3. The coupling electronics 23 can be configured on the basis of semiconductor components in a manner known per se. For example a DC-DC-converter can be provided as coupling device 23. Preferably the coupling device is configured bi-directionally so that the auxiliary storage 10 is charged with energy form the accumulator 9.

A further charge possibility results in the described manner by transmitting recuperation energy 27 during braking of the motor vehicle 2 by means of a drive motor 13. Also this recuperation energy 27 can be temporarily stored in the auxiliary storage 10 and can then be transmitted by means of the coupling device 23 into the accumulator 9.

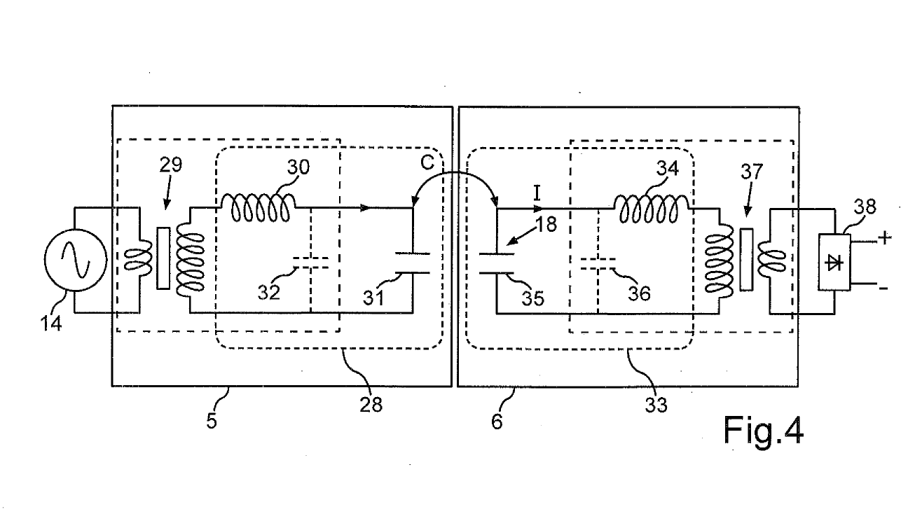

FIG. 4 illustrates a transmission principle by means of which the energy can be transmitted from the charging station 5 to the charging device 6 on the basis of the electric alternating field. The charging station 5 can have an oscillating circuit 2 which can be fed with electric energy from the mains supply 14 via a transformer 29. The oscillating circuit 28 can have an inductivity 30 and a capacitance 31. Optionally an own frequency of the oscillating circuit 28 can be adjusted by means of a further capacitance 32. The charging device 6 can also have an oscillating circuit 33 which can have an inductivity 34 and a capacitance 35. Also an own energy frequency of the oscillating circuit 33 can optionally be adjusted by means of an additional capacitance 36. The capacitance 31 of the oscillating circuit 28 and the capacitance 35 of the oscillating circuit 33 can each be formed by capacitor elements which each have a pair of electrically conductive capacitor bodies or capacitor plates or otherwise configured capacitor poles or capacitor electrodes.

The shape of the capacitor electrodes is selected so that a coupling capacitance C between the capacitances 31, 35 is formed in order to scatter the electric alternating field formed between the capacitor electrodes of the capacitance 31 during operation of the oscillating circuit 28, so that the alternating field also acts on the capacitor electrodes of the capacitance 35 of the oscillating circuit 33 and the capacitance 35 is alternately charged and discharged. This generates an alternating current I in the oscillating circuit 33 which is coupled out of the oscillating circuit 33 by means of a transformer 37 and can for example be converted with a rectifier 38 into the DC current for charging the auxiliary storage 10. Alternatively the charging station 5 and the charging device 6 can be configured according to WO 2007/107642 (PCT/FR2006/000614).

The transport system 1 has several advantages compared to the state of the art. Currently many industrial trucks are operated with lead accumulators. Lead accumulators contain environmental pollutants. In addition a long charging period is required so that the lead accumulator have to be removed from an industrial truck and be replaced for charged lead accumulators so that the lead accumulators can be charged while the vehicle remains operational. In addition the separate storage of lead accumulator requires a large amount of space. A fast charging of the lead accumulators results in a short service life, i.e., a faster ageing or reduced cycle number.

The described hybrid energy storage system of the energy storage 8 with the lithium-ion accumulator 9 and the auxiliary storage 10 offers a high performance energy storage in the form of an auxiliary storage 10 and a high energy storage in the form of the accumulator 9. in other words the accumulator generally has a greater storage capacity than the auxiliary storage. In addition energy for recharging the industrial truck with energy is transmitted capacitively. This capacitive recharging arrangement is wireless and can be multiply integrated in a production line, i.e., along a track. By means of an individual power pulse 7 the amount of energy that is transmitted does not have to be sufficient to fully charge the accumulator 9. Rather by repeatedly receiving a respective power pulse 7 the accumulator 9 can be charged stepless. Because the operation is very gentle, used/aged accumulators can be used in the hybrid energy storage system. The dimensioning of the power pulse 7 also enables using used/aged auxiliary storages, for example dual-layer capacitors.

The advantage is that principally the capacitive energy transmission device can transmit large amounts of energy for example 10 kilowatts, for 1 second to 10 minutes, in the form of the power pulse (Fast-pulse-charging) from a charging station 5 fed by a mains supply into the high-performance energy storage 10 and consequently the energy amount stored or temporarily stored in the high-power energy storage can be slowly and gently outputted to the high-energy storage by the charge electronics. This significantly increases the service life of the high-energy storage system. In addition the hybrid energy storage system does not have to be removed from the industrial truck, i.e., the time that would otherwise be required for replacing the energy storage is saved. Moreover, costs are saved because the accumulators do not have to be exchanged.

At the same time this hybrid energy storage system can be used for recuperation for example when lowering a load or during a braking procedure of the industrial truck. The possibility to recharge at multiple charging sites at the charging station within a short period of time, for example in a production line, enables optimizing the entire transport system regarding use of installation space and energy reserves.

As shown in FIG. 3 and FIG. 4 a pulse-like energy transmission occurs in the ideal case via the control unit 17 and the electrodes of the capacitances 31, 33 (for example as approximate Diarc-pulse) in the direction of the receiving unit 16. The energy is temporarily stored in the high-performance energy storage system (for example SuperCaps) of the storage 10. Preferably a great energy pulse (greater than 1 kilovolt) is transmitted via high-voltage only when the sender and the receiver of the energy are known (communication necessary), is then used and distributed to the (smart cell) batteries of the accumulator 9.

By means of a (charge) electronics the available energy can be transmitted via the high-performance energy storage into the high-energy storage (for example lithium-ion battery system) significantly more slowly (energy=power×time) and gently. As a result of the low charge rates the high-energy storage (lithium-ion battery) can be operated over a long service live. In the case of withdrawal of energy from the energy storage systems the high energy, in combination with the high-power energy storage and the interposed (charge)electronics, can react to the required load withdrawal. Predominantly the high-performance energy storage can be provided for dynamic load situations (recuperation: braking, lowering of loads) and the high-energy storage for stationary energy provision (for example when the industrial truck drives from station to station).

Generally this arrangement can be used for any motor vehicle equipped with an electric energy storage system.

Generally the energy coupling can be implemented capactively (see FIG. 4). In this case a further high-voltage circuit/-storage is present in the industrial truck, wherein the term high-voltage means a voltage value of greater than 60 Volt. The energy coupling can of course also be inductive but can also be contact based.

By means of the transport system also a so called “limp-home” operation can be achieved in case of a defective battery system.

The optimization of the overall system thus ensures a long service life and effective configuration of industrial trucks. Even the “2^{nd} life/use” principle of used/aged battery systems/modules, for example of electric vehicles, can hereby be utilized. In addition it is for example possible to install used dual-layer capacitors (SuperCaps), which for example originate from wind power plants or from other SuperCap applications (Derricks, current stabilizers etc.) and have to be replaced/renewed after years of service, even though the SuperCaps would otherwise still be usable. With this a consistent “2^{nd}-life” or new-component-concept can be realized.

In particular in the case of wind power plants many mechanical components age after for example 10 years—therefore all components including the dual-layer capacitors are replaced. Subsequently these used dual-layer capacitors are in most cases simply scrapped. Dual-layer capacitors are used in wind power plants for positioning the rotor blades in a neutral position for example in case of a power outage. This prevents uncontrolled rotation or destruction of the wind power plant.

Overall the example illustrates how the invention can provide a fast pulse charging (fast-pulse-charging) for electric vehicles.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A vehicle, comprising:
an electric drive motor for driving the vehicle;
an electrochemical accumulator for storing and providing electric energy for the drive motor, said accumulator being configured to only take up a charging power which is smaller than a predetermined maximal power value;
an electric auxiliary storage for storing and providing electric energy for the drive motor, said auxiliary storage being configured to take up a charging power during charging which is greater than the maximal power value;
a charging device for receiving energy from a vehicle-external charging station as a power pulse which has an amplitude greater that the maximal power value and to store the received energy in the auxiliary storage; and
a coupling circuit coupling the auxiliary storage with the accumulator and configured to transmit the energy from the auxiliary storage into the accumulator with a charging power which is smaller than the maximal power value.

2. The vehicle of claim 1, wherein the auxiliary storage has at least one of a capacitor a flywheel energy storage, and a magnetic storage for storing the energy received via the charging device.

3. The vehicle of claim 1, wherein the charging device has an electric capacitor element configured to receive the power pulse as an electric alternating field.

4. The vehicle of claim 1, further comprising an inverter control for controlling an inverter (21) of the drive motor, said inverter control being configured to operate the drive motor (13) during reception of the power pulse by the charging device.

5. The vehicle of claim 1, further comprising a processor configured to adjust a route plan to a destination so that the vehicle successively passes multiple said charging station (5) on the way to the destination.

6. The vehicle of claim 1, wherein the charging device and the auxiliary storage are configured to receive an amplitude of more than 8 kilowatts as the power pulse.

7. The vehicle of claim 1, further comprising a dynamoelectric converter which is different from the drive motor, wherein the auxiliary storage is configured to receive and store electric recuperating power from the drive motor and/or the dynamoelectric converter.

8. The vehicle of claim 1, wherein the vehicle is configured as an industrial truck and/or as pilotless vehicle.

9. A transport system for transporting items, comprising:
at least one vehicle, said at least one vehicle comprising an electric drive motor for driving the vehicle, an electrochemical accumulator for storing and providing electric energy for the drive motor, said accumulator being configured to only take up a charging power which is smaller than a predetermined maximal power value, an electric auxiliary storage for storing and providing electric energy for the drive motor, said auxiliary storage being configured to take up a charging power during charging which is greater than the maximal charge value, a charging device for receiving energy from a vehicle-external charging station as a power pulse which has an amplitude greater that the maximal power value and to store the received energy in the auxiliary storage, and a coupling circuit coupling the auxiliary storage with the accumulator and configured to transmit the energy from the auxiliary storage into the accumulator with a charging power which is smaller than the maximal power value;
at least one track for the at least one vehicle;
charging stations integrated in the track and/or at the border of the track each said charging station being configured to generate a power pulse for the charging device of the at least one vehicle.

10. A method for transmitting energy in a vehicle, comprising:
providing a vehicle, said vehicle comprising an electric drive motor for driving the vehicle, an electrochemical accumulator for storing and providing electric energy for the drive motor, said accumulator being configured to only take up a charging power which is smaller than a predetermined maximal power value, an electric auxiliary storage for storing and providing electric energy for the drive motor, said auxiliary .storage being configured to take up a charging power during charging which is greater than the maximal charge value, a charging device for receiving energy from a vehicle-external charging station as a power pulse which has an amplitude greater that the maximal power value and to store the received energy in the auxiliary storage, and a coupling circuit coupling the auxiliary storage with the accumulator and configured to transmit the energy from the auxiliary storage into the accumulator with a charging power which is smaller than the maximal power value;
driving the vehicle successively to a respective charging station, said vehicle receiving a power pulse from the respective charging station and after departure from the respective charging station at least partially charges the accumulator with the energy of the received power pulse.
